(19) United States
(12) Patent Application Publication
(10) Pub. No.: US 2021/0319259 A1
(43) Pub. Date: Oct. 14, 2021

(54) METHOD AND APPARATUS FOR EXTRACTING A PATTERN OF TIME SERIES DATA

(71) Applicant: SAMSUNG SDS CO., LTD., Seoul (KR)

(72) Inventors: Young Seon LEE, Seoul (KR); Joo Hyung YOU, Seoul (KR)

(21) Appl. No.: 17/230,036

(22) Filed: Apr. 14, 2021

(30) Foreign Application Priority Data
Apr. 14, 2020 (KR) 10-2020-0045066

(51) Int. Cl. G06K 9/62; G06Q 10/04

(52) U.S. Cl. CPC G06K 9/6227; G06Q 10/04; G06K 9/6224; G06K 9/6296

(57) ABSTRACT

A method for extracting a pattern of time series data according to an embodiment of the present disclosure includes truncating a first pattern extraction data to a first window size to generate a plurality of second pattern extraction data, clustering the plurality of second pattern extraction data to extract a plurality of reference patterns, selecting a first reference pattern from among the plurality of reference patterns based on a result of comparing sample data with a first section of the first reference pattern among the plurality of reference patterns, and calculating a loss value of the first window size using a second section of the selected first reference pattern.

### CROSS REFERENCE TO RELATED APPLICATIONS AND CLAIM OF PRIORITY

This application claims the benefit of Korean Patent Application No. 10-2020-0045066, filed on Apr. 14, 2020, in the Korean Intellectual Property Office, the disclosure of which is incorporated herein by reference in its entirety.

### BACKGROUND

### 1. Field

The present invention relates to a method for extracting and predicting patterns of time series data. In more detail, it relates to a pattern extraction and prediction method of time series data for generating multi window pattern data from time series data.

### 2. Description of the Related Art

For companies, product demand forecasting is an important criterion in marketing planning, inventory management, and distribution channel management. In general, demand forecasting is performed by analyzing time series data representing past sales information and deriving future forecasts based on this. In addition to forecasting the demand for specific products, such time series data forecasting can be used in various industries for various purposes, such as the purpose of optimally managing the power supply of power plants, and the purpose of timely response to disasters such as typhoons.

However, since the types of time series data used for prediction of time series data are very diverse, it is always difficult to predict future data by processing these data. In particular, it is often difficult to clearly derive the autocorrelation implied in time series data, and it is not uncommon that sufficient data for analysis cannot be obtained since enough time does not pass to collect time series data. In the past, to overcome these difficulties, each time a specific type of time series data was predicted, an appropriate analysis model was individually designed, but there was a problem that steps requiring a lot of effort and time of analysis experts, such as EDA (Exploratory Data Analysis), are essentially needed.

### SUMMARY

The technical problem to be solved through one or more embodiments of the present invention is to provide a method for extracting and predicting a pattern of time series data that does not require the intervention of an analysis expert in analyzing time series data and is universally applicable regardless of the type of data to be analyzed.

Another technical problem to be solved through one or more embodiments of the present invention is to provide a method for extracting and predicting a pattern of time series data that can automatically extract patterns in an appropriate size and number according to the characteristics of a data set without determining in advance the size or number of patterns to be extracted.

Another technical problem to be solved through one or more embodiments of the present invention is to provide a method for extracting and predicting a pattern of time series data that can perform prediction based on time series data of similar properties even when the past data on the prediction target is not sufficiently secured.

The technical problems of the present invention are not limited to the technical problems mentioned above, and other technical problems that are not mentioned will be clearly understood by those skilled in the art from the following description.

According to an embodiment of the disclosure, a method for extracting a pattern of time series data is performed by a computing device and comprises truncating a first pattern extraction data to a first window size to generate a plurality of second pattern extraction data, clustering the plurality of second pattern extraction data to extract a plurality of reference patterns, selecting a first reference pattern from among the plurality of reference patterns based on a result of comparing sample data with a first section of the first reference pattern among the plurality of reference patterns, and calculating a loss value of the first window size using a second section of the selected first reference pattern.

According to an embodiment of the disclosure, an apparatus for extracting a pattern of time series data comprises a processor, a memory for loading a computer program executed by the processor, and a storage for storing the computer program, wherein the computer program comprises instructions for performing operations comprising, truncating a first pattern extraction data to a first window size to generate a plurality of second pattern extraction data, clustering the plurality of second pattern extraction data to extract a plurality of reference patterns, selecting a first reference pattern from among the plurality of reference patterns based on a result of comparing sample data with a first section of the first reference pattern among the plurality of reference patterns, and calculating a loss value of the first window size using a second section of the selected first reference pattern.

According to various embodiments of the present invention, it is possible to analyze time series data without the intervention of an analysis expert to predict the subsequent data flow, and since it does not depend on the type of data to be analyzed, a single analysis model can be universally applied to various types of data.

Further, since patterns can be automatically extracted in an appropriate size and number according to the characteristics of a data set, there is no need to determine in advance the size and number of patterns to be extracted.

Further, it is possible to extract a time series pattern of similar properties and perform prediction based on this, even for objects, for which past data has not been sufficiently collected.

The effects of the present invention are not limited to the above-mentioned effects, and other effects not mentioned will be clearly understood by those skilled in the art from the embodiments of the present invention.

### BRIEF DESCRIPTION OF THE DRAWINGS

These and/or other aspects will become apparent and more readily appreciated from the following description of the embodiments, taken in conjunction with the accompanying drawings in which:

FIG. 1 is a diagram conceptually illustrating a method for extracting and predicting patterns of time series data disclosed in the present invention;

FIG. 2 is a flowchart illustrating a method for extracting and predicting patterns of time series data according to an embodiment of the present invention;

FIGS. 3 and 4 are diagrams for describing an embodiment, in which the pre-processing step S100 of FIG. 2 is embodied;

FIG. 5 is an exemplary flow chart, in which the step S200 of generating a pattern in FIG. 2 is further embodied;

FIG. 6 is a diagram illustrating a specific operation of the step S210 of generating a plurality of pattern extraction data in FIG. 5;

FIGS. 7 to 9 are diagrams for describing an embodiment, in which the step S220 of extracting the reference patterns of FIG. 5 is embodied;

FIG. 10 is an exemplary flow chart, in which the step S230 of calculating the loss value of FIG. 5 is further embodied;

FIGS. 11 and 12 are diagrams for describing an embodiment, in which the step S231 of selecting the most similar reference pattern of FIG. 10 is embodied;

FIG. 13 is a diagram for describing an embodiment, in which the step S232 of calculating a loss value using the prediction section of FIG. 10 is embodied;

FIG. 14 is an exemplary flow chart, in which the step S240 of adjusting the maximum window size of FIG. 5 is further embodied;

FIGS. 15 to 18 are diagrams for describing an embodiment, in which the prediction step S300 of FIG. 2 is embodied; and

FIG. 19 is a hardware configuration diagram illustrating an exemplary computing device, in which embodiments according to the present invention may be implemented.

### DETAILED DESCRIPTION

Hereinafter, preferred embodiments of the present disclosure will be described with reference to the attached drawings. Advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present invention, when it is determined that the detailed description of the related well-known configuration or function may obscure the gist of the present invention, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the invention. In this specification, the singular also includes the plural unless specifically stated otherwise in the phrase.

In addition, in describing the component of this invention, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

Hereinafter, some embodiments of the present invention will be described in detail with reference to the accompanying drawings.

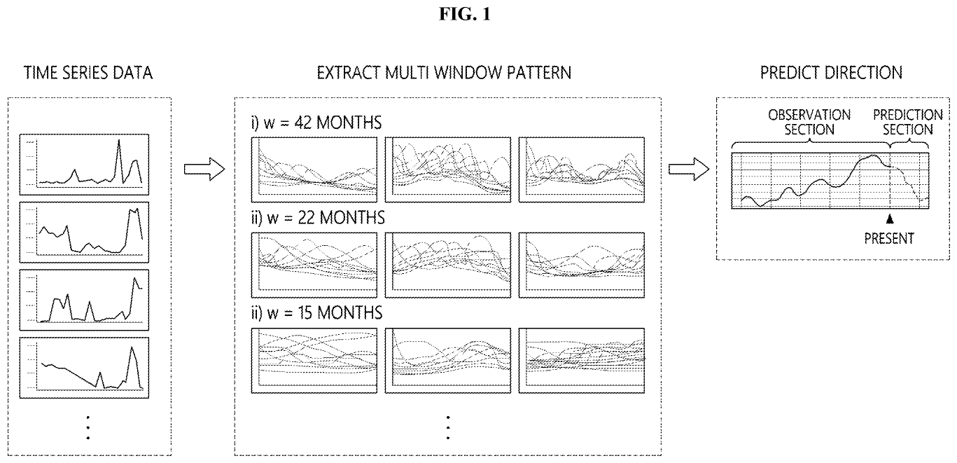

FIG. 1 is a diagram illustrating a method for extracting a pattern of time series data disclosed in the present invention. FIG. 1 conceptually illustrates a flow of extracting a multi window pattern from time series data and predicting the direction of observation data based on the extracted pattern.

The present invention extracts patterns inherent in time series data by clustering time series data. In the process, time series data is truncated (or cut) to a predetermined window size, and the truncated data are automatically clustered with similar ones.

At this time, in the present invention, as shown in FIG. 1, given time series data can be hierarchically truncated and clustered to a plurality of different window sizes (for example, 42 months, 22 months, 15 months, or 42 weeks, 22 weeks, 15 weeks, or 42 days, 22 days, 15 days, etc.) to configure a plurality of clusters for each window size. Then, for each cluster configured for each window size, a reference pattern representing the corresponding cluster is extracted to configure a reference pattern set for time series prediction (multi window pattern extraction).

The purpose of this multi window pattern extraction is to extract patterns of various lengths inherent in time series data. For example, each time series data set has an intrinsic pattern (or feature) based on its property, and if time series data is truncated to a large window size, long-term patterns and long-period features are better extracted, and if time series data is truncated to a small window size, short-term patterns and short-period features are better extracted. Therefore, in order to increase the accuracy of prediction, it is desirable to extract not only a long-term pattern but also a short-term pattern, and consider them in a complex manner.

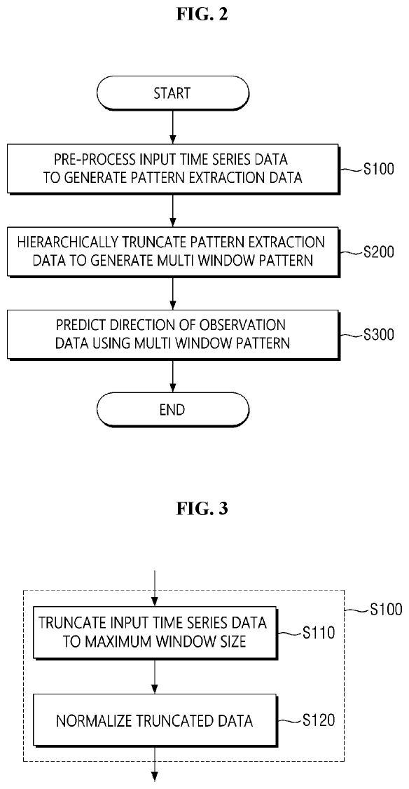

When the reference pattern set is prepared, observation data for prediction is input. Further, among the reference pattern sets, reference patterns having an observation section most similar to the observation data are selected, and prediction data for the observation data are calculated by synthesizing the prediction sections of the selected reference patterns. Since the method for extracting the reference pattern and predicting using the same will be described in more detail in FIG. 2 and the following drawings, detailed descriptions thereof will be omitted here in order to avoid overlapping descriptions.

Meanwhile, in the present invention, when the truncated time series data is clustered, an optimal cluster is automatically configured using a non-parametric clustering method. In this way, it is not necessary to determine the number of clusters and the clustering criteria of the truncated data in advance, so that an expert's help is not required in the clustering step, and an automated EDA can be more easily implemented. In this case, DPGMM (Dirichlet Process Gaussian Mixture Model) may be used as a non-parametric clustering method.

According to the time series data pattern extraction method of the present invention, the size of the pattern suitable for the characteristics of the time series data set can be automatically determined and patterns according to the corresponding pattern size can be automatically extracted, and the user does not need to determine the size and number of patterns in advance.

Further, according to the present invention, improved prediction accuracy can be expected than that of a conventional general prediction model. In general, the most easily accessible prediction models include MA (Moving Average) or EWMA (Exponentially Weighted Moving Average), but according to the present invention, prediction accuracy is significantly improved compared to such existing prediction models.

Further, in the present invention, it is possible to relatively clearly identify the effect of explanatory variables in time series data, in which various explanatory variables (or independent variables) may exist, and it is possible to serve as a baseline model, in which further improvement can be attempted.

Furthermore, when prediction for a new object, for which the past data is not sufficiently accumulated, is required, the existing prediction models cannot accurately predict it without sufficient learning data for the new object, whereas in the present invention, since a common pattern can be extracted from other time series data having similar properties to the new object and prediction for the new object can be performed based on this, it is possible to perform the prediction relatively accurately even if the past data is not accumulated.

Lastly, unlike the deep learning model, the prediction method according to the present invention is not a black box model, and thus the causal relationship leading to the result can be clearly grasped, so that the reason for the prediction result can be easily explained.

As such, the present invention has various effects superior to existing prediction models and methods, and hereinafter, specific embodiments of the present invention and operating principles thereof will be described in detail with reference to the accompanying drawings.

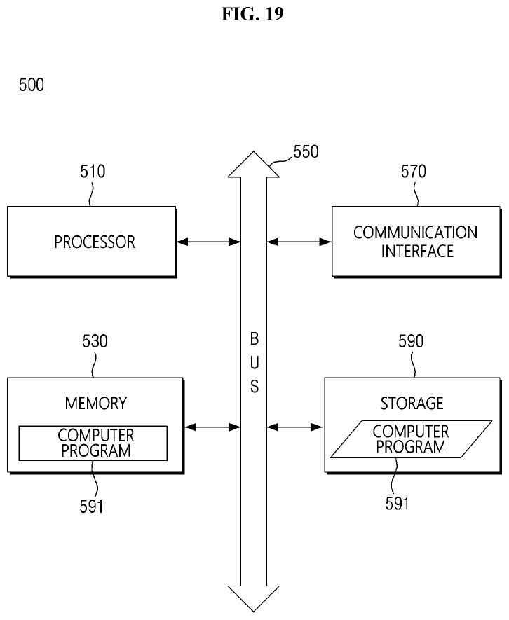

FIG. 2 is a flowchart illustrating a method of extracting a pattern of time series data according to an embodiment of the present invention. The method of extracting a pattern of time series data illustrated in FIG. 2 is performed by an apparatus for extracting a pattern of time series data that can be implemented with the computing device 500 illustrated in FIG. 19. Therefore, in the methods in FIG. 2 and the following drawings, when the performing subject of each step is not specified, it is assumed that the performing subject is the pattern extraction apparatus.

In step S100, the pattern extraction apparatus obtains the input time series data, and then pre-processes it to generate pattern extraction data. At this time, the pre-processed input data is raw data having time series properties, and the pattern extraction apparatus generates pattern extraction data used for clustering and pattern analysis by processing the input time series data in a form suitable for a later step.

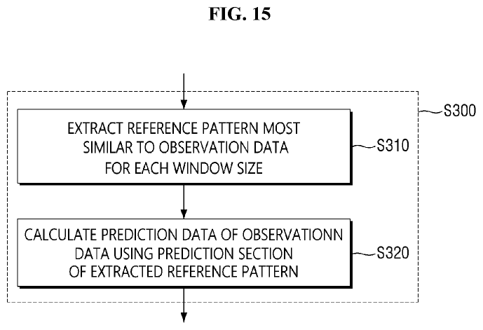

In step S200, the pattern extraction apparatus hierarchically truncates the pre-processed pattern extraction data to extract a reference pattern set for time series prediction (multi window pattern extraction). Here, hierarchical truncation means repetitive truncation of time series data with a plurality of different window sizes described in FIG. 1 above. In this case, the window sizes to be truncated are determined according to an algorithm for finding the optimum window size, which will be described in detail later in FIG. 15. When the reference pattern set is extracted by hierarchically truncating the pattern extraction data into a plurality of window sizes, data prediction using the same becomes possible.

In step S300, the pattern extraction apparatus receives the observation data and predicts the direction of the observation data using the extracted reference pattern set. At this time, the pattern extraction apparatus selects at least one or more reference patterns most similar to the observation data for each window, and then calculates prediction data for the observation data by summing the selected reference patterns. The calculated prediction data represents a future direction and movement of the observation data, and the pattern extraction apparatus may calculate the prediction data through a weighted summing method, in which different weights are applied according to a degree of similarity between the selected reference pattern and the observation data.

On the other hand, here, although the process of the present invention has been described in terms of three steps of the ‘pre-processing step (S100)’ of generating pattern extraction data, the ‘pattern generation step (S200)’ of extracting a multi window pattern from pattern extraction data, and the ‘prediction step (S300)’ of predicting the direction of the observation data using the extracted multi window pattern, the method according to the present invention does not necessarily have to include all three steps sequentially or in all. For example, if the purpose is only exploratory data analysis (EDA) for time series data sets, the ‘prediction step (S300)’ is not necessary, and in this case, the method according to the present invention may consist of only two parts of the ‘pre-processing step (S100)’ and ‘pattern generation step (S200).’

In the following, detailed descriptions of the ‘pre-processing step (S100),’ the ‘pattern generation step (S200),’ and the ‘prediction step (S300)’ will be described along with specific embodiments.

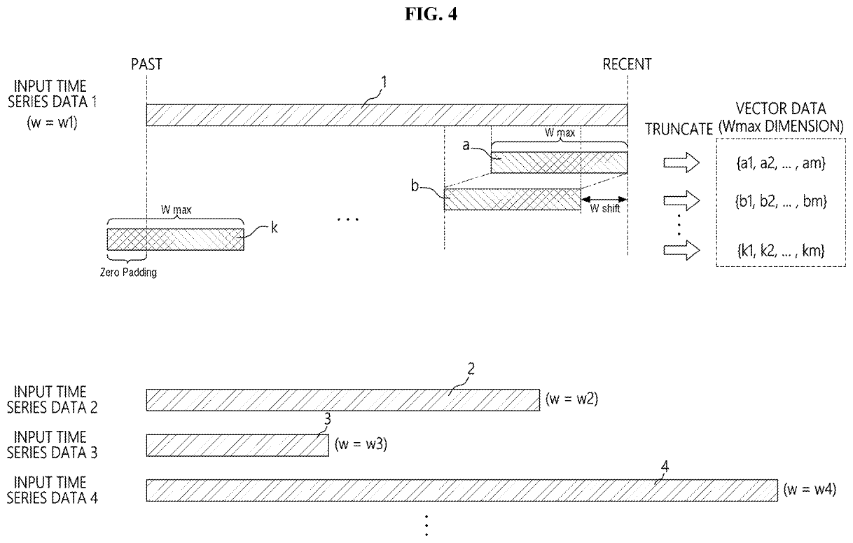

FIGS. 3 and 4 are diagrams for describing an embodiment, in which the pre-processing step (S100) of FIG. 2 is embodied.

First, referring to FIG. 3, in step S110, the pattern extraction apparatus truncates the provided input time series data to the maximum window size. This means that the input time series data is truncated in advance to a size that facilitates pattern extraction so that subsequent steps can be smoothly performed. For example, each input time series data is respectively truncated to a predetermined maximum window size. A specific embodiment for this is shown in FIG. 4.

Referring to FIG. 4, a plurality of input time series data 1, 2, 3, and 4 are input, and among them, input time series data 1 (1) is truncated to the maximum window size (Wmax). The method of truncation of input time series data 1 (1) will be described in detail as follows. First, the input time series data 1 (1) is truncated to the maximum window size (Wmax) by taking the most recent data of the input time series data 1 (1) as a starting point (a), then moved by the shift size (Wshift) and then truncated back to the maximum window size (Wmax) (b). By repeatedly performing this, the input time series data 1 (1) is sequentially truncated to the end (k). The truncated data may have a vector data format having the maximum window size (Wmax) dimension, as shown in FIG. 4. Here, it has been illustrated that truncation is performed by taking the most recent data as a starting point, but the scope of the present invention is not limited thereto. For example, contrary to the embodiment of FIG. 4, it is also possible to sequentially truncate to the most recent data by taking the most past data as a starting point.

On the other hand, when truncating with the method illustrated in FIG. 4, the remaining portion of the input time series data 1(1) that is truncated the very last may be smaller in size than the truncating window size (Wmax). In this case, the data (k) that is truncated at the last becomes partially empty, and in order to match the data format, the front part without data is filled with ‘0’ (Zero-Padding) to make all of the vector data have the same size.

Truncation of the maximum window size (Wmax) is performed in the same way for the remaining input time series data (2, 3, 4), and all data obtained by truncating the input time series data (1, 2, 3, 4) are collected and then provided to later steps.

Returning back to FIG. 3, in step S120, the pattern extraction apparatus normalizes the previously truncated data. The input time series data (1, 2, 3, 4) may be data collected in various environments, and in this case, the numerical units (or scales) of each input time series data may be significantly different from each other. In the present invention, in order to focus on the pattern and trend rather than the numerical value of the input time series data, the difference in the numerical unit (or scale) is resolved by normalizing the previously truncated data.

Normalization of the truncated data may be performed by the method of Equation 1 below using the average and standard deviation of each.

y(x−m)/s [Equation 1]

Here, x is the truncated data,

m is the average of the truncated data,

s is the standard deviation of the truncated data,

y is the normalized data.

The data that has gone through the normalization process are provided as pattern extraction data for clustering and pattern extraction to later ‘pattern generation step (S200).’

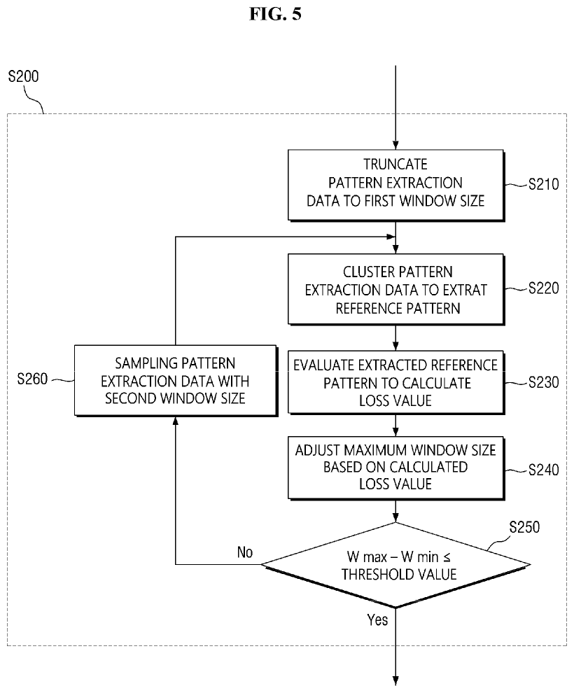

FIGS. 5 to 15 are diagrams illustrating specific embodiments for describing the pattern generation step (S200) of FIG. 2.

FIG. 5 is an exemplary flow chart, in which the pattern generation step (S200) of FIG. 2 is further embodied. In FIG. 5, a series of methods of re-truncating the pre-processed pattern extraction data to a predetermined window size, clustering the generated pattern extraction data, and then evaluating it to determine whether to repeat the truncation again with other window size are shown. Hereinafter, it will be described in detail with reference to the drawings.

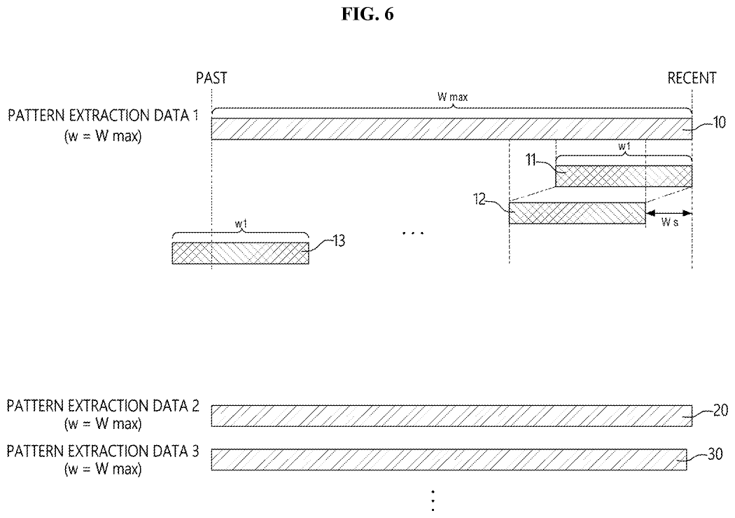

In step S210, the pattern extraction apparatus truncates the provided pattern extraction data to the first window size (w1). A specific example of this will be described with reference to FIG. 6. FIG. 6 shows a plurality of pattern extraction data 10, 20, and 30 having a size (or dimension) of a maximum window size (Wmax). The pattern extraction apparatus truncates a plurality of pattern extraction data 10, 20, and 30 to a predetermined window size. As for a specific truncation method, a method similar to the truncation method in the pre-processing step (S100) may be used. Alternatively, in addition to the above method, based on the maximum window size (Wmax), they are truncated to a specific window size (W1) only once by taking the most recent data as the starting point, and then used as the pattern extraction data corresponding to the window size (W1). In this case, the maximum number of pattern extraction data is exactly the same as the number of data obtained based on the maximum window size (Wmax).

As a specific example, the truncation of the pattern extraction data 1 (10) is described. The pattern extraction apparatus truncates the pattern extraction data 1 (10) to the first window size (w1) by taking the most recent data as a starting point (11), and moves by the shift size (Ws), and truncates again it to the first window size (w1) (12). By repeatedly performing this, the pattern extraction data 1 (10) is sequentially truncated to the very end (13). Meanwhile, similarly to the above, in FIG. 5, it is illustrated that truncation is performed by taking the most recent data as a starting point, but the scope of the present invention is not limited thereto. For example, contrary to the embodiment of FIG. 5, it is also possible to sequentially truncate to the most recent data by taking the most past data as a starting point. Further, as described above, even in the embodiment of FIG. 5, when the data 13 that is truncated at the last becomes partially empty, Zero-Padding may be performed to fill the front part without data with ‘0’ in order to match the data format. When the truncation of the pattern extraction data 1 (10) is completed, the truncation is performed in the same manner for the other pattern extraction data (20, 30), and finally, a plurality of pattern extraction data having a first window size (w1) are obtained from the pattern extraction data (10, 20, 30).

As an embodiment, the first window size (w1) may be a specific value preset by the user, or may be a value determined depending on a preset maximum window size (Wmax) and minimum window size (Wmin), for example (Wmax+Wmin)/2.

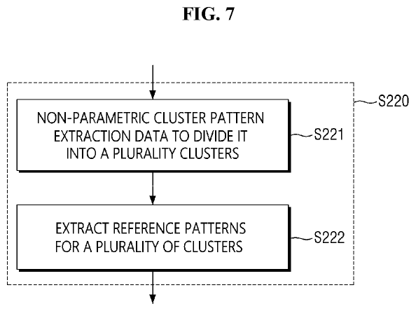

Returning back to FIG. 5, in step S220, the pattern extraction apparatus clusters pattern extraction data and extracts reference patterns for each cluster. FIGS. 7 to 9 will be referred to in order to describe a specific embodiment of this.

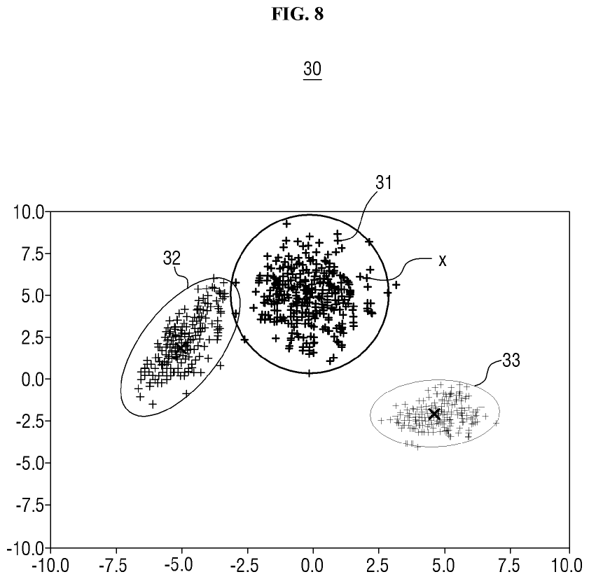

FIG. 7 shows a flow chart, in which step S220 is embodied. First, in step S221, the pattern extraction apparatus clusters pattern extraction data among similar ones using DPGMM, which is one of the representative non-parametric clustering methods. As such, clustering using DPGMM has the advantage of automating all of the clustering logic since there is no need to predetermine the number of clusters. An exemplary form of a clustering method using DPGMM is shown in FIG. 8. Referring to FIG. 8, in DPGMM, each pattern extraction data (X) is clustered close to each other or separated from each other according to the degree of similarity, and pattern extraction data that are close to each other are clustered and divided into a plurality of clusters 31, 32, 33.

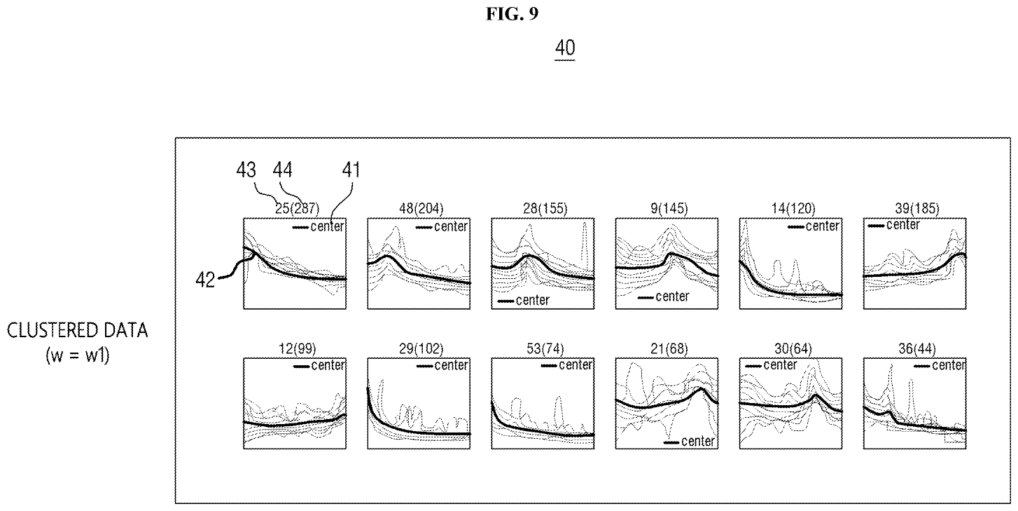

Next, in step S222, after the clustering is completed, the pattern extraction apparatus determines and extracts a reference pattern representing the corresponding cluster based on the pattern extraction data constituting each cluster, and the extracted reference patterns are stored as reference patterns corresponding to the first window size. Determination of these reference patterns can also be automatically performed by DPGMM. An exemplary form of determining reference patterns for a plurality of clusters is illustrated in FIG. 9. In FIG. 9, pattern extraction data 40 having a first window size (w1) are clustered into 12 clusters. Above the cluster 41, a unique number 43 indicating the cluster and the number of pattern extraction data constituting the cluster 44 are described for reference, and the reference pattern 42 of each cluster is indicated by a bold solid line for readability.

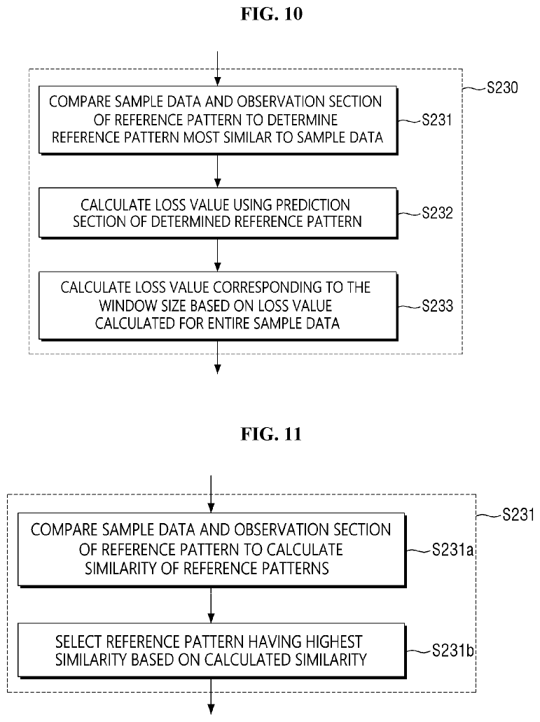

Returning back to FIG. 5, when reference patterns are extracted for clusters of the first window size (w1) in step S220, the extracted reference patterns are evaluated in step S230, and as a result, the loss value of the first window size (w1) is calculated. The loss value at this time is an index for estimating how accurately the actual prediction will be performed when the reference patterns extracted to the first window size (w1) are used. Specific embodiments for calculating this will be described with reference to FIGS. 10 to 14.

Referring to FIG. 10, in step S231, the pattern extraction apparatus determines a reference pattern most similar to the sample data by comparing the extracted reference patterns with the observation section of the sample data. Here, the sample data is data referenced to evaluate the extracted reference patterns, and may be data of a maximum window size (Wmax) dimension. As an embodiment, pattern extraction data having a maximum window size (Wmax) generated through truncation in step S100 or step S210 may be provided as comparison target data at this time. Specifically, the pattern extraction apparatus compares all elements (sample data) of the sample data set with reference patterns corresponding to the corresponding window size, for example, the first window size (w1), and determines the most similar reference pattern for each individual sample data.

This will be further described with reference to FIG. 11. In FIG. 11, a more detailed embodiment of step S231 is shown. In FIG. 11, the pattern extraction apparatus selects any one sample data (e.g., sample data 1) from a sample data set, and compares the selected sample data and observation sections of the reference patterns to calculate the similarity of each reference pattern (S231a). Then, based on the calculated similarity, a reference pattern having the highest similarity is determined as a reference pattern corresponding to the selected sample data (S231b).

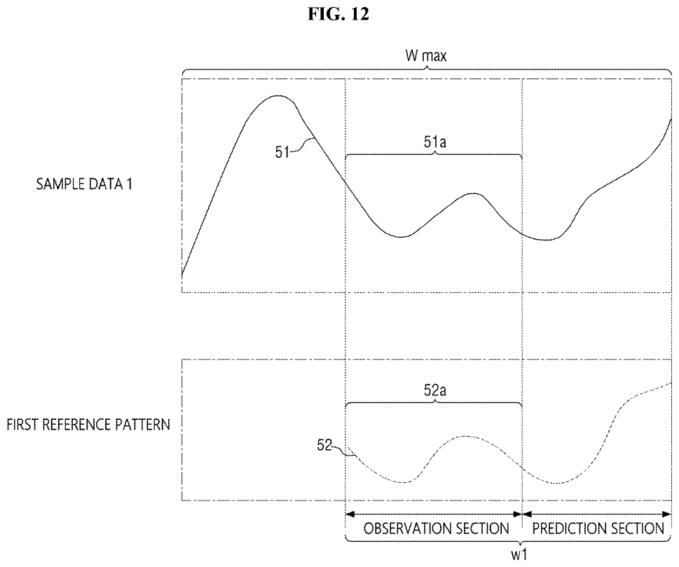

Here, the observation section is a section referred to when comparing the reference pattern with sample data, and in the present invention, the reference pattern is composed of an observation section and a prediction section. It will be further described with reference to FIG. 12.

The sample data 1 (51) is shown in the upper part of FIG. 12, and the first reference pattern 52 of the reference patterns is shown in the lower part. As described above, the first reference pattern 52 is data truncated to the first window size (w1), and is divided into the observation section 52a used when comparing the sample data 1 (51) and the reference pattern, and the prediction section used when calculating a loss value thereafter. In this case, when calculating the similarity of the first reference pattern 52, the pattern extraction apparatus compares only the observation section 51a of the sample data 1 (51) and the observation section 52a of the first reference pattern 52 with each other for calculation.

As an embodiment, the size of the observation section or the size of the prediction section may be determined in various ways. For example, if the size of the prediction section may be first determined with a specific value and the size of the observation section may be determined with a value dependent thereon (for example, if the size of the prediction section is first determined as 3, the size of the observation section is automatically determined as 2 when the window size is 5). Conversely, the size of the observation section may be first determined with a specific value, and the size of the prediction section may be determined with a value dependent thereon. Alternatively, each size may be determined depending on the first window size (w1) so that the size of the observation section and the size of the prediction section form a predetermined ratio (for example, in the case that the size of the observation section and the size of the prediction section is the ratio of 2:3, if the size of the first window is 10, the size of the observation section is automatically determined as 4 and the size of the prediction section is automatically determined as 6).

As an embodiment, various methods may be used as a method of calculating the similarity between the observation section of the reference patterns and the observation section of the sample data. For example, a method using a distance between two different vectors, a probability determination method used to allocate certain data to a specific cluster in DPGMM, or various other methods may be used to calculate the similarity.

Returning back to FIG. 10, in step S232, the pattern extraction apparatus calculates a loss value for individual sample data by using the prediction section of the determined reference pattern. In this case, the pattern extraction apparatus may calculate a loss value by scoring a difference from the most similar reference pattern for all sample data of the sample data set.

In this case, various methods may be used as a method of calculating the loss value. For example, the Euclidean distance between the reference pattern and the sample data is calculated and the result may be used as a loss value, MSE (Mean Square Error), RMSE (Root Mean Square Error), or MAPE (Mean Absolute Percentage Error) is calculated and the result may be used as a loss value.

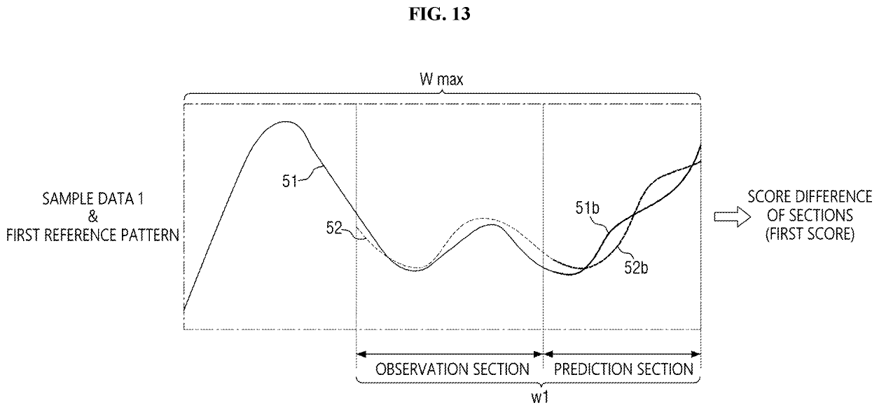

This will be further described with reference to FIG. 13. FIG. 13 conceptually illustrates a specific example of calculating a loss value according to the method of FIG. 10.

Referring to FIG. 13, sample data 1 (51) and a first reference pattern 52 are compared. The first reference pattern 52 is a reference pattern determined to be the most similar to the sample data 1 (51) in step S231. In this way, the difference between the sample data and the most similar reference pattern is scored to calculate a loss value, but only prediction sections of each data are used to calculate the loss value at this time. As an example of FIG. 13, when calculating the loss value for the sample data 1 (51), only the prediction sections 51b and 52b of the sample data 1 (51) and the first reference pattern 52 are compared, and the observation section is not considered.

Returning back to FIG. 10, in step S233, the pattern extraction apparatus finally calculates a loss value corresponding to the first window size (w1) based on the loss values calculated for each sample data. At this time, various methods can be used to calculate the loss value of the first window size (w1), but in the simplest, the result of simply summing all the loss values calculated so far may be determined as the loss value of the first window size (w1).

Returning back to FIG. 5, after evaluating the extracted reference patterns, i.e., after calculating the loss value of the first window size (w1), in step S240, the pattern extraction apparatus determines the maximum window size (Wmax) or the minimum window size (Wmin) based on the calculated result value.

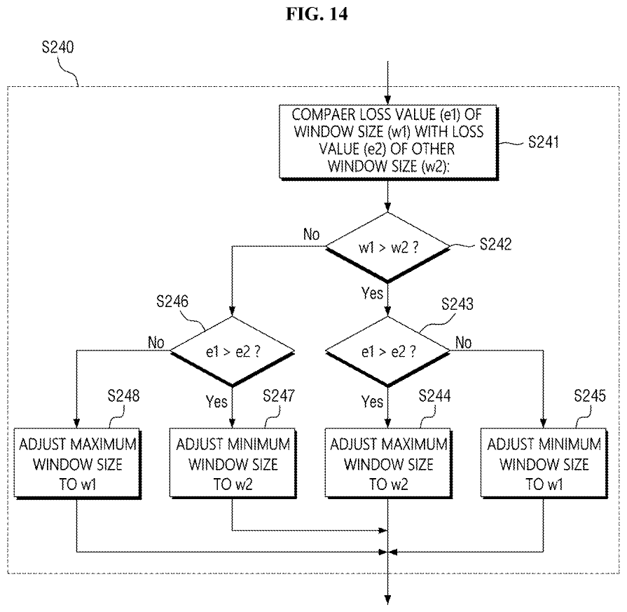

Step S240 is a step for finding an optimum window size, and the pattern extraction apparatus compares a loss value of the first window size (w1) and a previously calculated loss value of other window size (e.g., Wmax or Wmin) to adjust the maximum/minimum window size (Wmax/Wmin) by narrowing the window range (i.e., the range from Wmin to Wmax) to close to the optimum window size. In this case, the optimum window size means a window size having the smallest loss value among window sizes within the window range. The present invention adjusts the maximum/minimum window size (Wmax/Wmin) until the optimum window is reached to narrow the window range toward the optimum window, and finds out the optimum window through the method of repeating the hierarchical truncation and evaluation for the window of other size within the narrowed window range. In this regard, a specific embodiment, in which the pattern extraction apparatus adjusts the maximum/minimum window size, will be described with reference to FIG. 14.

Referring to FIG. 14, a method of finding an optimum window size in a manner similar to a binary search is illustrated. The method of FIG. 15 is based on the assumption that the loss value graph for the entire window range will show a concave or convex shape, and when this is followed, it is not necessary to obtain a loss value for all window sizes, and the optimum window size can be effectively searched by comparing the loss value of the recently calculated window size with the loss value of the previously calculated window size and narrowing the range of the window size to be searched next in the direction, in which the optimum window size exists.

First, in step S241, the pattern extraction apparatus compares the loss value (ea) of the recently calculated window size (wa, for example, the first window size) with the previously calculated loss value (eb) of the other window size (wb). In this case, the other window size (wb) may be a maximum window size (Wmax) or a minimum window size (Wmin).

In step S242, the pattern extraction apparatus determines whether the window size (wa) is larger than the other window size (wb). If the window size (wa) is larger than the other window sizes (wb), the present embodiment proceeds to step S243. Otherwise, the present embodiment proceeds to step S246.

In step S243, it is determined whether the loss value (ea) of the window size (wa) is greater than the loss value (eb) of the other window size (wb). If the loss value (ea) of the window size (wa) is greater than the loss value (eb) of the other window size (wb), the present embodiment proceeds to step S244. Otherwise, the present embodiment proceeds to step S245.

In step S244, the pattern extraction apparatus adjusts the maximum window size to the other window size (wb). In this case, the loss value (ea) of the window size (wa) is greater than the loss value (eb) of the existing other window size (wb), and it can be seen that the optimum window size exists in the other window size (wb) side. At this time, since wa>wb, in order to narrow the range of the window size in the direction, in which the optimum window size exists, the maximum window size (Wmax) should be moved toward the other window size (wb). Accordingly, the pattern extraction apparatus adjusts the maximum window size (Wmax) to the other window size (wb).

On the other hand, in step S245, the pattern extraction apparatus adjusts the minimum window size to the window size (wa). In this case, the loss value (ea) of the window size (wa) is less than the loss value (eb) of the existing other window sizes (wb), and it can be seen that the optimum window size exists in the window size (wa) side. At this time, since wa>wb, in order to narrow the range of the window size in the direction, in which the optimum window size exists, the minimum window size (Wmin) should be moved toward the window size (wa). Accordingly, the pattern extraction apparatus adjusts the minimum window size (Wmin) to the window size (wa).

On the other hand, step S246 is a case where the window size (wa) is less than or equal to the other window size (wb), and the pattern extraction apparatus determines whether a loss value (ea) of the window size (wa) is greater than the loss value (eb) of the other window size (wb). If the loss value (ea) of the window size (wa) is greater than the loss value (eb) of the other window size (wb), the present embodiment proceeds to step S247. Otherwise, the present embodiment proceeds to step S248.

In step S247, the pattern extraction apparatus adjusts the minimum window size to the other window size (wb). In this case, the loss value (ea) of the window size (wa) is greater than the loss value (eb) of the existing other window size (wb), and it can be seen that the optimum window size exists in the other window size (wb) side. At this time, since wa≤wb, in order to narrow the range of the window size in the direction, in which the optimum window size exists, the minimum window size (Wmin) should be moved toward the other window size (wb). Accordingly, the pattern extraction apparatus adjusts the minimum window size (Wmin) to the other window size (wb).

On the other hand, in step S248, the pattern extraction apparatus adjusts the maximum window size to the window size (wa). In this case, the loss value (ea) of the window size (wa) is less than the loss value (eb) of the existing other window size (wb), and it can be seen that the optimum window size exists in the window size (wa) side. At this time, since wa≤wb, in order to narrow the range of the window size in the direction, in which the optimum window size exists, the maximum window size (Wmax) should be moved toward the window size (wa). Accordingly, the pattern extraction apparatus adjusts the maximum window size (Wmax) to the window size (wa).

Returning back to FIG. 5, in step S250, the pattern extraction apparatus determines whether the difference between the maximum window size (Wmax) and the minimum window size (Wmin) is less than or equal to a threshold value. As an embodiment, the threshold value may be 0.

As a result of the determination, if the difference between the maximum window size (Wmax) and the minimum window size (Wmin) is less than or equal to the threshold value, the present embodiment proceeds to step S300 assuming that reference patterns having the optimum window size have been found. Otherwise, the present embodiment proceeds to step S260, truncates again the pattern extraction data to the second window size (w2), returns to step S220, and repeats the process of ‘clustering-reference pattern extraction-evaluation of reference patterns-adjusting of the maximum/minimum window size’ thereafter.

On the other hand, various window sizes (w1, w2, . . . , etc.) and their reference patterns searched through this process repetition are stored in the storage space of the pattern extraction apparatus, added to the list of the window size set and reference pattern set managed by the pattern extraction apparatus, and used for future time series data prediction.

So far, a series of methods for generating pattern extraction data through pre-processing from input data and hierarchically truncating the generated pattern extraction data to extract reference patterns of different dimensions have been described.

Now, in FIGS. 15-18, a method of predicting the direction of observation data using the extracted reference patterns will be described. FIGS. 15 to 18 are diagrams illustrating embodiments for specifically describing the prediction step (S300) of FIG. 2. The method shown in FIG. 15 is a method related to prediction of time series data, but the performing subject is referred to as the pattern extraction apparatus in the same manner as before for consistency of name.

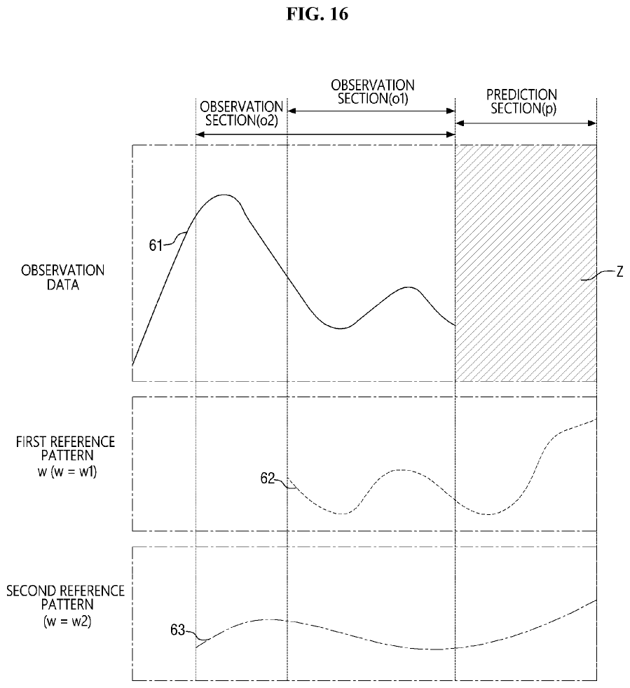

First, referring to FIG. 15, in step S310, the pattern extraction apparatus receives observation data to be predicted, and selects a reference pattern that is most similar to the observation data for each window size in the window size set. In this case, the observation data means data to be predicted using the extracted reference pattern. The pattern extraction apparatus selects reference patterns that are most similar to the observation data for each window size by comparing the observation section of each reference pattern with the observation data. FIG. 16 will be referred to for a clear understanding of this. Referring to 16, input observation data 61 is shown at the top. And, below that, the first reference pattern 62 selected as the most similar to the observation data 61 among reference patterns of the first window size (w1), and the second reference pattern 63 selected as most similar to the observation data 61 among the reference patterns of the second window size (w2) are shown. When comparing the reference patterns of each window size (w1, w2) with the observation data 61, the pattern extraction apparatus compares the reference patterns with the comparison target data 61 only for a section corresponding to the observation section of the reference patterns. For example, when comparing the reference patterns of the first window size (w1) and the observation data 61, both can be compared only in the observation section (o1) corresponding to the first window size (w1), and when comparing the reference patterns of the second window size (w2) and the observation data 61, both can be compared only in the observation section (o2) corresponding to the second window size (w2).

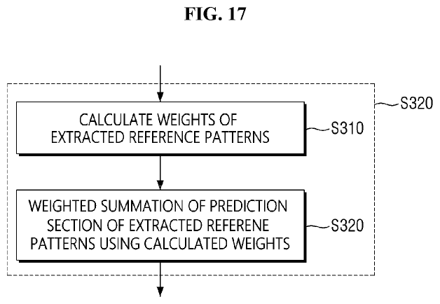

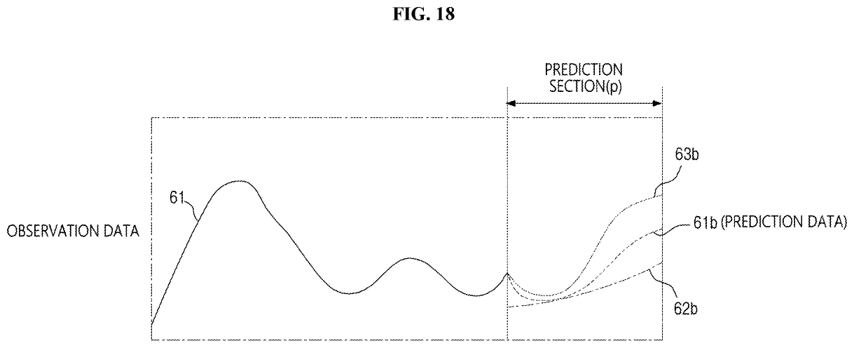

Returning back to FIG. 15, in step S320, the pattern extraction apparatus calculates prediction data of the observation data by using the prediction sections of the selected reference patterns. In step S310, since one reference pattern is selected for each window size, finally, the same number of reference patterns as the window size set will be selected. In this case, the pattern extraction apparatus calculates a result of weighted summation of the prediction sections of the selected reference patterns as prediction data of the observation data. A detailed description of this will be continued with reference to FIGS. 17 and 18.

Referring to FIG. 17, in step S320a, the pattern extraction apparatus calculates weights for each of the selected reference patterns. This is to determine whether the input observation time series is more similar to a long-term reference pattern (i.e., a pattern with a larger window size) or a short-term reference pattern (i.e., a pattern with a smaller window size), and grant a higher weight to a more similar reference pattern.

Various methods can be used as a method of calculating the weight of each reference pattern. As an embodiment of such a weight calculation method, a similarity calculation method using a Euclidean distance between observation data and an observation section of a reference pattern may be used. That is, since the similarity between the observation data and the observation section of the reference pattern is inversely proportional to its Euclidean distance, the weight can be calculated easily through the method, in which after the similarity is calculated using the Euclidean distance, the weight of each reference pattern is determined in proportion to the calculated similarity. The method of calculating the similarity using the Euclidean distance is widely known in the art, so a detailed description thereof will be omitted. Meanwhile, in general, the Euclidean distance tends to be calculated smaller as the observation section of the reference pattern is shorter. Therefore, in order to prevent distortion of the result, as an embodiment, the similarity between the observation data and the reference pattern is calculated based on a value obtained by dividing the calculated Euclidean distance of the reference pattern by the length of the observation section, and accordingly, the weight of the reference pattern may be determined.

Further, as another embodiment of the weight calculation method, a method of using a loss value corresponding to each reference pattern may be used. For example, based on the loss value of the window size, to which each reference pattern belongs, the loss value of each reference pattern may be calculated so that the weight increases as the loss value decreases.

In a specific example, assuming that reference patterns selected for prediction are the first reference pattern 62 and the second reference pattern 63, and the loss values of the first window size (w1) and the second window size (w2) corresponding to them are 0.5 and 0.25, respectively, the first reference pattern 62 may be calculated as 1 and the second reference pattern 63 may be calculated as 2 so that the weights of the reference patterns 62 and 63 are in inverse proportion to the corresponding loss value (the second reference pattern having a loss value of 2 times smaller has a weight 2 times higher). Meanwhile, it will be apparent to those skilled in the art that various methods other than the method of using the Euclidean distance and the method of using the corresponding loss value described above may be used to calculate the weight of the reference pattern.

In step S320b, the pattern extraction apparatus weighs and sums the prediction sections of the selected reference patterns using the calculated weight, and calculates prediction data of the observation data through this.

FIG. 18 conceptually illustrates an example, in which prediction data of observation data is calculated by weighting and summing prediction sections of selected reference patterns. Referring to FIG. 18, it can be seen that the prediction sections 63b and 62b of the selected reference patterns 62 and 63 are weighted and summed to obtain the prediction data 61b of the observation data 61.

As an embodiment, in this case, in order to prevent discontinuity between the prediction section and the observation section of the observation data 61, the beginning portion of the prediction section may be adjusted to close to the last data of the observation section.

Hereinafter, an exemplary computing device 500 that can implement an apparatus and a system, according to various embodiments of the present disclosure will be described with reference to FIG. 19.

FIG. 19 is an example hardware diagram illustrating a computing device 500.

As shown in FIG. 19, the computing device 500 may include one or more processors 510, a bus 550, a communication interface 570, a memory 530, which loads a computer program 591 executed by the processors 510, and a storage 590 for storing the computer program 591. However, FIG. 19 illustrates only the components related to the embodiment of the present disclosure. Therefore, it will be appreciated by those skilled in the art that the present disclosure may further include other general purpose components in addition to the components shown in FIG. 19.

The processor 510 controls overall operations of each component of the computing device 500. The processor 510 may be configured to include at least one of a Central Processing Unit (CPU), a Micro Processor Unit (MPU), a Micro Controller Unit (MCU), a Graphics Processing Unit (GPU), or any type of processor well known in the art. Further, the processor 510 may perform calculations on at least one application or program for executing a method/operation according to various embodiments of the present disclosure. The computing device 500 may have one or more processors.

The memory 530 stores various data, instructions and/or information. The memory 530 may load one or more programs 591 from the storage 590 to execute methods/operations according to various embodiments of the present disclosure. An example of the memory 530 may be a RAM, but is not limited thereto.

The bus 550 provides communication between components of the computing device 500. The bus 550 may be implemented as various types of bus such as an address bus, a data bus and a control bus.

The communication interface 570 supports wired and wireless internet communication of the computing device 500. The communication interface 570 may support various communication methods other than internet communication. To this end, the communication interface 570 may be configured to comprise a communication module well known in the art of the present disclosure.

The storage 590 can non-temporarily store one or more computer programs 591. The storage 590 may be configured to comprise a non-volatile memory, such as a Read Only Memory (ROM), an Erasable Programmable ROM (EPROM), an Electrically Erasable Programmable ROM (EEPROM), a flash memory, a hard disk, a removable disk, or any type of computer readable recording medium well known in the art.

The computer program 591 may include one or more instructions, on which the methods/operations according to various embodiments of the present disclosure are implemented. For example, the computer program 591 comprises instructions for performing operations comprising truncating a first pattern extraction data to a first window size to generate a plurality of second pattern extraction data, clustering the plurality of second pattern extraction data to extract a plurality of reference patterns, selecting a first reference pattern from among the plurality of reference patterns based on a result of comparing sample data with a first section of the first reference pattern among the plurality of reference patterns, and calculating a loss value of the first window size using a second section of the selected first reference pattern.

When the computer program 591 is loaded on the memory 530, the processor 510 may perform the methods/operations in accordance with various embodiments of the present disclosure by executing the one or more instructions.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although the operations are shown in a specific order in the drawings, those skilled in the art will appreciate that many variations and modifications can be made to the preferred embodiments without substantially departing from the principles of the present invention. Therefore, the disclosed preferred embodiments of the invention are used in a generic and descriptive sense only and not for purposes of limitation. The scope of protection of the present invention should be interpreted by the following claims, and all technical ideas within the scope equivalent thereto should be construed as being included in the scope of the technical idea defined by the present disclosure.

What is claimed is:

1. A method for extracting a pattern of time series data comprising:
truncating a first pattern extraction data to a first window size to generate a plurality of second pattern extraction data;
clustering the plurality of second pattern extraction data to extract a plurality of reference patterns;
selecting a first reference pattern from among the plurality of reference patterns based on a result of comparing sample data with a first section of the first reference pattern among the plurality of reference patterns; and
calculating a loss value of the first window size using a second section of the selected first reference pattern.

2. The method of claim 1 further comprising:
a pre-processing step of generating the first pattern extraction data by truncating input time series data to a maximum window size and normalizing the input time series data truncated to the maximum window size.

3. The method of claim 1, wherein the extracting of the plurality of reference patterns comprises:
dividing the plurality of second pattern extraction data into a plurality of clusters by performing non-parametric clustering; and
determining a reference pattern for each of the divided plurality of clusters.

4. The method of claim 1, wherein the selecting of the first reference pattern comprises:
comparing first sections of the plurality of reference patterns with a first section of the sample data, respectively to calculate a similarity of each of the plurality of reference patterns with respect to the sample data; and
selecting the first reference pattern among the plurality of reference patterns based on the calculated similarity.

5. The method of claim 1, wherein the extracting of the plurality of reference patterns comprises storing the plurality of reference patterns as a reference pattern corresponding to the first window size.

6. The method of claim 1, wherein the calculating of the loss value comprises scoring a difference between a second section of the first reference pattern and a second section of the sample data to calculate a loss value for the sample data.

7. The method of claim 6, wherein the calculating of the loss value further comprises calculating a loss value of the first window size based on the loss value for the sample data and a loss value for other sample data.

8. The method of claim 1, further comprising:
adjusting a maximum window size or a minimum window size based on the calculated loss value,
wherein the sample data is data truncated to the maximum window size obtained from the first pattern extraction data; and
the first window size is a value less than or equal to the maximum window size.

9. The method of claim 8, wherein the adjusting of the maximum window size comprises comparing the loss value of the first window size with a loss value of other window size to reduce the maximum window size or increase the minimum window size.

10. The method of claim 8, further comprising:
determining whether a difference between the maximum window size and the minimum window size is less than or equal to a threshold value; and
truncating the first pattern extraction data to a second window size smaller than the maximum window size to generate a plurality of other second pattern extraction data if the difference is greater than the threshold value.

11. The method of claim 10, wherein the second window size is different from the first window size;
the plurality of reference patterns are stored as reference pattern data corresponding to the first window size; and
a plurality of other reference patterns generated by clustering the plurality of other second pattern extraction data are stored as reference pattern data corresponding to the second window size.

12. The method of claim 1, further comprising:
predicting a direction of observation data using the plurality of reference patterns.

13. The method of claim 12, wherein the predicting of the direction of observation data comprises calculating prediction data of the observation data based on a second section of the first reference pattern and a second section of a second reference pattern having a different window size from the first reference pattern.

14. The method of claim 13, wherein the calculating of the prediction data comprises:
calculating a first weight of the first reference pattern and a second weight of the second reference pattern; and
performing weighted summation of the second section of the first reference pattern and the second section of the second reference pattern using the first weight and the second weight.

15. The method of claim 14, wherein the first weight is calculated by dividing a Euclidean distance between the first section of the first reference pattern and comparison target data by a length of the first section.

16. The method of claim 14, wherein the first weight is calculated based on the loss value of the first window size corresponding to the first reference pattern.

17. An apparatus for extracting a pattern of time series data, the apparatus comprising:
a processor;
a memory for loading a computer program executed by the processor; and
a storage for storing the computer program,
wherein the computer program comprises instructions for performing operations comprising:
truncating a first pattern extraction data to a first window size to generate a plurality of second pattern extraction data;
clustering the plurality of second pattern extraction data to extract a plurality of reference patterns;
selecting a first reference pattern from among the plurality of reference patterns based on a result of comparing sample data with a first section of the first reference pattern among the plurality of reference patterns; and
calculating a loss value of the first window size using a second section of the selected first reference pattern.

18. The apparatus of claim 17, wherein the computer program further comprises instructions for performing an operation of predicting a direction of observation data using the plurality of reference patterns.
